(19) United States
(12) Patent Application Publication
(10) Pub. No.: US 2026/0008935 A1
(43) Pub. Date: Jan. 8, 2026

(54) POLYIMIDE FILM AND MANUFACTURING METHOD THEREFOR

(71) Applicant: Pl ADVANCED MATERIALS CO., LTD., Chungcheongbuk-do (KR)

(72) Inventors: Dong-Young KIM, Chungcheongbuk-do (KR); Dae-Geon YOO, Chungcheongbuk-do (KR); Dong-Young WON, Chungcheongbuk-do (KR)

(21) Appl. No.: 18/850,951

(22) PCT Filed: Mar. 28, 2023
(86) PCT No.: PCT/KR2023/004071

§ 371 Date: Sep. 29, 2025

(30) Foreign Application Priority Data
Mar. 30, 2022 (KR) 10-2022-0039548

(51) Int. Cl. C09D 179/08

(52) U.S. Cl. CPC C09D 179/08

(57) ABSTRACT

The present invention provides a polyimide film and a manufacturing method therefor, wherein in the dimension change measurement by a thermomechanical analyzer (TMA) that performs a temperature rise procedure from 25° C. to 400° C. after storage for 48 hours at a humidity of 50% RH, the temperature-rise thermal expansion coefficient (50 to 200° C.) in the TD direction is −1.5 ppm/° C. to 6 ppm/° C., the temperature-rise thermal expansion coefficient (50 to 200° C.) being the slope of a straight line connecting a dimensional measurement value in the TD direction of the polyimide film as measured at 200° C. in the first run during the temperature rise procedure and a dimensional measurement value in the TD direction of the polyimide film as measured at 50° C. in the first run during the temperature rise procedure, and the dimensional measurement values in the TD direction correspond to dimensional change values calculated by converting, into 1 m, the length of a sample of the polyimide film used in the measurement by the thermomechanical analyzer.

### TECHNICAL FIELD

The present disclosure relates to a polyimide film having excellent dimensional stability even after being exposed to humidity for a predetermined period of time and to a method of manufacturing the same.

### BACKGROUND ART

Polyimide (PI) is a polymeric material having the highest level of heat resistance, chemical compatibility, electrical insulation, chemical resistance, and weather resistance of all organic materials due to containing an imide ring having excellent chemical stability along with a rigid aromatic main chain.

Polyimide films are attracting attention as a material for various electronic devices requiring the abovementioned properties.

Examples of microelectronic components to which polyimide films are applied include flexible thin circuit boards with high circuit integration density to cope with weight reduction and size reduction in electronic products. In particular, polyimide films are widely used as insulating films for thin circuit boards.

Such a thin circuit board typically has a structure in which a circuit including a metal foil is formed on an insulating film, which is referred to as a flexible metal-clad laminate in a broad sense and, in a narrower sense, is sometimes referred to as a flexible copper-clad laminate (FCCL) when using a thin copper plate as a metal foil.

Methods of manufacturing flexible metal-clad laminates may, for example, include (i) a casting method in which a polyamic acid, a precursor of polyimide, is cast or applied onto a metal foil and then imidized, (ii) a metalizing method in which a metal layer is directly installed on a polyimide film through sputtering, and (iii) a laminate method in which a polyimide film and a metal foil are bonded using heat and pressure through a thermoplastic polyimide.

In particular, the metalizing method is a method of producing a flexible metal-clad laminate by, for example, sputtering a metal such as copper on a polyimide film having a thickness in the range of 20 to 38 μm to sequentially deposit a tie layer and a seed layer. This method is advantageous in forming ultrafine circuits in which a circuit pattern has a pitch of 35 μm or smaller and is widely used to manufacture flexible metal-clad laminates for chip on film (COF).

Polyimide films used in manufacturing actual flexible metal-clad laminates are in environments with varying humidity, temperature, and the like while undergoing steps of pre-manufacturing, transportation, storage, and the like.

In particular, after being exposed to humidity in the steps of transportation, storage, and the like, the dimensional stability of polyimide films deteriorates in the process involving high-temperature application during the manufacturing step of flexible metal-clad laminates, which has been problematic.

Therefore, there is an urgent need for polyimide films whose dimensional stability is maintained even after being exposed to certain environments (especially humidity) in the steps of transportation, storage, and the like.

The foregoing background description is intended to provide an understanding of the background of the present disclosure and may include matters not known in the related art to those skilled in the field to which the technology belongs.

### DOCUMENT OF RELATED ART

### Patent Document

(Patent Document 1) Korean Patent No. 10-1258432

### DISCLOSURE

### Technical Problem

Accordingly, the present disclosure aims to provide a polyimide film having excellent dimensional stability even after being exposed to humidity for a predetermined period of time.

However, the problems to be solved by the present disclosure are not limited to the above description, and other problems can be clearly understood by those skilled in the art from the following description.

### Technical Solution

In a first aspect of the present disclosure for achieving the objective as described above,
a polyimide film having a temperature-rise coefficient of thermal expansion (50° C. to 200° C.) in a transverse direction (TD) of −1.5 ppm/° C. or higher and 6 ppm/° C. or lower in dimensional change measurement by a thermomechanical analyzer (TMA) involving a temperature rise process from 25° C. to 400° C. after being stored for 48 hours under a humidity condition of 50% RH,
wherein the temperature-rise coefficient of thermal expansion (50° C. to 200° C.) is a slope of a straight line connecting a TD dimensional measurement value of the polyimide film measured at a temperature of 200° C. and a TD dimensional measurement value of the polyimide film measured at a temperature of 50° C. in the first run during the temperature rise process, and
the TD dimensional measurement values correspond to dimensional change values calculated by converting a sample length of the polyimide film used in the TMA measurement into 1 m,
is provided.

A second aspect of the present disclosure provides a method of manufacturing the polyimide film, the method including the following processes: providing a polyamic acid solution to be obtained from an acid dianhydride component and a diamine component; applying the polyamic acid solution onto a support through cast coating and heating the resulting product to manufacture a self-supporting film of the polyamic acid solution; and imidizing and stretching the self-supporting film to manufacture a polyimide film.

A third aspect of the present disclosure provides a flexible metal-clad laminate including: the polyimide film described above; and an electrically conductive metal foil.

A fourth aspect of the present disclosure provides an electronic component including the flexible metal-clad laminate.

### Advantageous Effects

The present disclosure provides a polyimide film having excellent dimensional stability even after being exposed to humidity for a predetermined period of time, thereby providing a polyimide film having excellent dimensional stability in a metal foil lamination process.

Such a polyimide film can be applied to various fields in need of polyimide films having excellent dimensional stability, for example, flexible metal-clad laminates manufactured by a metalizing method and electronic components including such flexible metal-clad laminates.

### DESCRIPTION OF DRAWINGS

FIG. 1 is a graph showing dimensional change measurement results of polyimide films of Examples 1 and 4 herein by a TMA involving a temperature rise process from 25° C. to 400° C.; and

FIG. 2 is a graph showing dimensional change measurement results of polyimide films of Comparative Examples 1 and 4 herein by a TMA involving a temperature rise process from 25° C. to 400° C.

### BEST MODE

All terms or words used herein and in the appended claims should not be construed as being limited to general and dictionary meanings, but will be interpreted based on the meanings and concepts corresponding to the technical aspects of the present disclosure on the basis of the principle that any inventor is allowed to define the terms appropriately for the best explanation.

Therefore, the embodiments described herein are merely preferred examples and do not exhaustively present the technical spirit of the present disclosure. Accordingly, it should be appreciated that there may be various equivalents and modifications that can replace the embodiments and the configurations at the time at which the present application is filed.

As used herein, the singular forms are intended to include the plural forms as well, unless the context clearly indicates otherwise. It will be further understood that the terms “comprise”, “include”, “have”, and the like when used herein, specify the presence of stated features, integers, steps, components, or combinations thereof but do not preclude the presence or addition of one or more other features, integers, steps, components, or combinations thereof.

As used herein, although the term “acid dianhydride” is intended to include precursors or derivatives thereof, these compounds may not technically be acid dianhydride. Nevertheless, these compounds will react with diamine to form polyamic acid, which will be converted to polyimide once more.

As used herein, although the term “diamine” is intended to include precursors or derivatives thereof, these compounds may not technically be diamines. Nevertheless, these compounds will react with dianhydride to form polyamic acid, which will be converted to polyimide once more.

When an amount, concentration, other value, or parameter is given herein as a range, preferred range, or enumeration of preferred upper values and preferred lower values, it should be understood to specifically disclose all ranges formed by pairing any upper range limit or a preferred value with any lower range limit or a preferred value, regardless of whether the ranges are additionally disclosed.

When a range of numerical values is mentioned herein, this range is intended to include not only the endpoints but also all integers and fractions within the range, unless otherwise stated. The scope of the present disclosure is not intended to be limited to the specific values mentioned when defining the scope.

A polyimide film, according to one embodiment of the present disclosure, has a temperature-rise coefficient of thermal expansion (50° C. to 200° C.) of −1.5 ppm/° C. or higher and 6 ppm/° C. or lower in dimensional change measurement by a TMA involving a temperature rise process from 25° C. to 400° C., wherein the temperature-rise coefficient of thermal expansion (50° C. to 200° C.) may be a slope of a straight line connecting a TD dimensional measurement value of the polyimide film measured at a temperature of 200° C. and a TD dimensional measurement value of the polyimide film measured at a temperature of 50° C. in the first run during the temperature rise process.

Additionally, the TD dimensional measurement values may correspond to dimensional change values calculated by converting a sample length of the polyimide film used in the TMA measurement into 1 m.

That is, in the polyimide film of the present disclosure, the slope of the straight line connecting the TD dimensional measurement values of the polyimide film measured at temperatures of 200° C. and 50° C. in the first run during the temperature rise process is −1.5 ppm/° C. or higher.

The polyimide film expands in the machine direction (MD) and TD during the temperature rise process. In actual FCCL manufacturing, the pattern progresses in the MD, while the PI film and Cu layer form a repeating pattern in the TD. Therefore, the expansion and shrinkage, especially in the TD, become key factors in determining the quality of FCCLs.

In the polyimide film of the present disclosure, the slope of the straight line is preferably 5.5 ppm/° C. or lower and more preferably 5.0 ppm/° C. or lower.

When the slope of the straight chain was −1.5 ppm/° C. or higher and 6 ppm/° C. or lower, the polyimide film had excellent dimensional stability even after being exposed to humidity for a predetermined period of time. Additionally, the dimensional stability of the polyimide film was maintained even after laminating a metal foil through coating, sputtering, and/or deposition.

When the slope of the straight chain was lower than −1.5 ppm/° C. and higher than 6 ppm/° C., the polyimide film had poor dimensional stability after being exposed to humidity for a predetermined period of time. Additionally, the quality of the flexible metal-clad laminate in which the metal foil was laminated through coating, sputtering, and/or deposition significantly deteriorated.

In this case, the TMA dimensional change measurement was performed under the following conditions.
Measurement mode: tensile mode, a load of 5 g,
Sample length: 16 mm (in TD),
Sample width: 4 mm,
Temperature rise start point: 25° C.,
Temperature rise end point: 400° C. (no retention time at 400° C.),
The polyimide film of the present disclosure may have a TD coefficient of thermal expansion (CTE) of the 1 ppm/° C. or higher and 10 ppm/° C. or lower.
Additionally, the polyimide film may have a moisture absorption rate of 1.5 wt % or less.

The polyimide film of the present disclosure is obtainable by reacting one or more acid dianhydride components and one or more diamine components through imidization. The one or more acid dianhydride components are selected from the group consisting of pyromellitic dianhydride (PMDA), oxydiphthalic dianhydride (ODPA), 3,3′,4,4′-biphenyltetracarboxylic dianhydride (s-BPDA), 2,3,3′,4′-biphenyltetracarboxylic dianhydride (a-BPDA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (BTDA), bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride, and 4,4′-(2,2-hexafluoroisopropylidene)diphthalic acid dianhydride.

Additionally, the one or more diamine components are selected from the group consisting of paraphenylenediamine (PPD), metaphenylenediamine, 3,3′-dimethylbenzidine, 2,2′-dimethylbenzidine, 2,4-diaminotoluene, 2,6-diaminotoluene, 3,5-diaminobenzoic acid (DABA), 4,4′-diaminodiphenylether (ODA), 3,4′-diaminodiphenylether, 4,4′-diaminodiphenylmethane(methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dimethoxybenzidine, 2,2′-dimethoxybenzidine, 3,3′-diaminodiphenylether, 3,4′-diaminodiphenylether, 4,4′-diaminodiphenylether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane.

The polyimide film is preferably obtainable by reacting a polyamic acid solution through an imidization reaction, the polyamic acid solution including: an acid dianhydride component including any one or more selected from the group consisting of 3,3′,4,4′-biphenyltetracarboxylic dianhydride (s-BPDA), pyromellitic dianhydride (PMDA), and 3,3′,4,4′-benzophenonetetracarboxylic dianhydride (BTDA); and a diamine component including any one or more selected from the group consisting of paraphenylenediamine (PPD), 4,4′-diaminodiphenylether (ODA), and 2,2′-dimethylbenzidine.

Additionally, the 3,3′,4,4′-biphenyltetracarboxylic dianhydride may have a content of 100 mol % or less, the pyromellitic dianhydride may have a content of 55 mol % or less, and the 3,3′,4,4′-benzophenonetetracarboxylic dianhydride may have a content of 60 mol % or less, based on 100 mol % of the total content of the acid dianhydride component.

In the meantime, the paraphenylenediamine may have a content of 50 mol % or more and 100 mol % or less, the 4,4′-diaminodiphenylether may have a content of 20 mol % or less, and the 2,2′-dimethylbenzidine may have a content of 50 mol % or less, based on the 100 mol % of the total content of the diamine component.

When the pyromellitic dianhydride content exceeds 55 mol %, the moisture absorption rate may be significantly high, deteriorating the dimensional stability against the moisture in the polyimide film manufactured.

In the meantime, when the 3,3′,4,4′-benzophenonetetracarboxylic dianhydride content exceeds 60 mol %, the modulus of the polyimide film manufactured may be significantly high, leading to brittleness.

Additionally, when the paraphenylenediamine content is less than 50 mol %, or the 4,4′-diaminodiphenylether content exceeds 20 mol %, the coefficient of thermal expansion of the polyimide film manufactured may be excessively high, deteriorating the thermal dimensional stability.

In the meantime, when the 2,2′-dimethylbenzidine content exceeds 50 mol %, the modulus of the polyimide film manufactured may be significantly high, leading to brittleness.

The preparation of the polyamic acid in the present disclosure may, for example, involve:
(1) a polymerization method by adding the entire amount of the diamine component in a solvent and then adding the acid dianhydride component so that the amount thereof is substantially equimolar to that of the diamine component;
(2) a polymerization method by adding the entire amount of the acid dianhydride component in a solvent and then adding the diamine component so that the amount thereof is substantially equimolar to that of the acid dianhydride component;
(3) a polymerization method by adding some of the diamine component to a solvent, mixing some of the acid dianhydride component in a ratio of about 95 to 105 mol % to the reaction component, adding the remaining diamine component, and then subsequently adding the remaining acid dianhydride component so that the diamine component and the acid dianhydride component are substantially equimolar;
(4) a polymerization method by adding some of the acid dianhydride component to a solvent, mixing some of the diamine compound in a ratio of about 95 to 105 mol % to the reaction component, adding the remaining acid dianhydride component, and then subsequently adding the remaining diamine component so that the diamine component and the acid dianhydride component are substantially equimolar;
(5) a polymerization method by reacting some of the diamine component and some of the acid dianhydride component in a first solvent so that either one is in excess to form a first composition, reacting some of the diamine component and some of the acid dianhydride component in a second solvent so that either one is in excess to form a second composition, and mixing the first and second compositions to complete polymerization, wherein when the diamine component is in excess when forming the first composition, the acid dianhydride component in the second composition is contained in an excessive amount, and when the acid dianhydride component is in excess in the first composition, the diamine component in the second composition is contained in an excessive amount to mix the first and second compositions so that the entire diamine component and acid dianhydride component used in the reaction are substantially equimolar; and the like.

In one specific example, a method of manufacturing the polyimide film, according to the present disclosure, may include the following processes:
providing a polyamic acid solution to be obtained from an acid dianhydride component and a diamine component;
applying the polyamic acid solution onto a support through cast coating and heating the resulting product to manufacture a self-supporting film of the polyamic acid solution; and
imidizing and stretching the self-supporting film to manufacture a polyimide film.

In the present disclosure, such polymerization methods of the polyamic acid described above may be defined as random polymerization methods. Additionally, the polyimide film of the present disclosure, manufactured from the polyamic acid prepared through the processes in such a manner, is preferably applicable in terms of maximizing the effect of the present disclosure for improving planarity.

However, the polymerization method makes the length of the repeating unit in the polymer chain described above relatively short, so there may be limitations in demonstrating each of the excellent properties of the polyimide chain derived from the acid dianhydride component. Therefore, a block polymerization method may be performed as the polymerization method of the polyamic acid, which is preferably usable in the present disclosure.

On the other hand, the solvent for synthesizing the polyamic acid is not particularly limited, and any solvent capable of dissolving the polyamic acid may be usable. However, an amide-based solvent is preferably used.

Specifically, the organic solvent may be a polar organic solvent, which may be, in particular, a polar aprotic solvent. Examples thereof may include one or more selected from the group consisting of N,N-dimethylformamide (DMF), N,N-dimethylacetamide, N-methyl-pyrrolidone (NMP), gamma-butyrolactone (GBL), and diglyme, but are not limited thereto. If necessary, the solvent may be used alone, or two or more types may be used in combination.

In one example, N,N-dimethylformamide and N,N-dimethylacetamide are further preferably used as the organic solvent.

Additionally, in the polyamic acid preparation process, fillers may be added to improve various properties of the film, such as sliding properties, thermal conductivity, corona resistance, loop hardness, and the like. The filler added is not particularly limited, but preferred examples thereof may include silica, titanium oxide, alumina, silicon nitride, boron nitride, calcium hydrogen phosphate, calcium phosphate, mica, and the like.

The particle diameter of the filler is not particularly limited but may be determined depending on the properties of a film to be modified and the type of fillers to be added. Typically, the average particle diameter is in the range of 0.05 to 100 μm, preferably in the range of 0.1 to 75 μm, more preferably in the range of 0.1 to 50 μm, and even more preferably in the range of 0.1 to 25 μm.

When the particle diameter is smaller than the above range, the modification effect may be poorly demonstrated, while the particle diameter is larger than the above range, the surface properties may be seriously damaged, or the mechanical properties may significantly deteriorate.

Additionally, the amount of the filler added is not particularly limited, but may be determined by the properties of a film to be modified, the particle diameter of the filler, or the like. Typically, the amount of the filler added is in the range of 0.01 to 100 parts by weight, preferably in the range of 0.01 to 90 parts by weight, and more preferably in the range of 0.02 to 80 parts by weight, with respect to 100 parts by weight of the polyimide.

When the amount of the filler added is smaller than the above range, the modification effect by the filler is poorly demonstrated, while when the amount of the filler added is greater than the above range, the mechanical properties of the film may be seriously damaged. The method of adding the filler is not particularly limited, and any known methods may be used.

In the manufacturing method of the present disclosure, the polyimide film may be manufactured by a thermal imidization method or a chemical imidization method.

Additionally, the polyimide film may be manufactured by a complex imidization method in combination of the thermal and chemical imidization methods.

The thermal imidization method is a method of inducing an imidization reaction using a heat source such as an infrared dryer or hot air, without involving a chemical catalyst.

The thermal imidization method may enable the amic acid group present in a gel film to be imidized by subjecting the gel film to heat treatment at variable temperatures in the range of 100° C. to 600° C. Specifically, the amic acid group present in the gel film may be imidized through the heat treatment performed at a temperature in the range of 200° C. to 500° C., which is more specifically in the range of 300° C. to 500° C.

However, even in the gel film formation process, some of the amic acid (about 0.1 mol % to 10 mol %) may be imidized. To this end, the polyamic acid composition may be dried at a variable temperature in the range of 50° C. to 200° C., which may also fall within the scope of the thermal imidization method.

In the case of the chemical imidization method, a dehydrating agent and an imidizing agent may be used according to methods known in the art, thereby manufacturing the polyimide film.

As one example of the complex imidization method, a dehydrating agent and an imidizing agent may be introduced into a polyamic acid solution, heated at a temperature in the range of 80° C. to 200° C., which is preferably in the range of 100° C. to 180° C., partially cured and dried, and then heated at a temperature in the range of 200° C. to 400° C. for 5 to 400 seconds, thereby manufacturing the polyimide film.

The present disclosure provides a flexible metal-clad laminate including the polyimide film described above and an electrically conductive metal foil.

The metal foil used is not particularly limited. However, when the flexible metal-clad laminate of the present disclosure is for use in electronic devices or electrical devices, the metal foil may, for example, include copper or an alloy thereof, stainless steel or an alloy thereof, nickel or an alloy thereof (including Alloy 42), and aluminum or an alloy thereof.

In typical flexible metal-clad laminates, copper foils, such as rolled copper foil and electrolytic copper foil, are widely used and are also preferably used in the present disclosure. Additionally, an anti-rust layer, a heat-resistant layer, or an adhesive layer may be applied onto the surface of such metal foils.

The thickness of the metal foil is not particularly limited in the present disclosure, and the metal foil may have a thickness capable of demonstrating sufficient functions depending on the intended use.

The flexible metal-clad laminate, according to the present disclosure, is obtainable through metal foil lamination, coating, sputtering, or deposition on at least one surface of the polyimide film.

Additionally, the flexible metal-clad laminate is available as a two-layer FCCL and is particularly usable in mobile phones, displays (liquid-crystal displays (LCD), plasma display panels (PDP), organic light-emitting diodes (OLED), and the like), and the like and for flexible printed circuit boards (FPCB) and COF.

Electronic components, including the flexible metal-clad laminate, may, for example, be communication circuits for mobile phones, communication circuits for computers, or communication circuits for aerospace, but are not limited thereto.

### MODE FOR INVENTION

Hereinbelow, the action and effect of the present disclosure will be described in detail through one specific preparation example and examples of the disclosure. However, the preparation example and examples are provided only for illustrative purposes, and the scope of the present disclosure is not limited to the following embodiments.

### Preparation Example: Manufacturing of Polyimide Film

A polyimide film of the present disclosure may be manufactured by typical methods known in the art, as follows. First, the acid dianhydride and diamine components mentioned above are allowed to react in an organic solvent to obtain a polyamic acid solution.

The acid dianhydride and diamine components may be introduced in a solution, powder, or lump form. Preferably, the reaction occurs by introducing the components in powder form at the beginning and then in solution form to control the polymerization viscosity.

The polyamic acid solution obtained in such a manner may be mixed with an imidization catalyst and a dehydrating agent and then applied onto a support.

Examples of the catalyst used include tertiary amines (for example, isoquinoline, β-picoline, pyridine, and the like), and examples of the dehydrating agent include anhydrous acids. However, the catalyst and the dehydrating agent are not limited thereto. Additionally, the support used above may be a glass plate, aluminum foil, circular stainless belt, stainless drum, or the like, but is not limited thereto.

The film applied onto the support is transformed into a gel on the support by drying air and heat treatment.

The gel-form film is separated from the support, subjected to heat treatment, dried, and then completely imidized.

The film obtained through the heat treatment above may be subjected to heat treatment under a predetermined tension to remove residual stress generated in the film during the film formation process.

Specifically, 500 ml of dimethylformamide (DMF) is introduced while injecting nitrogen into a reactor equipped with a stirrer and nitrogen injection/discharge pipes. The reactor temperature is set to 30° C., followed by introducing 3,3′,4,4′-biphenyltetracarboxylic dianhydride (BPDA), pyromellitic dianhydride (PMDA), 3,3′,4,4′-benzophenonetetracarboxylic dianhydride (BTDA), paraphenylenediamine (PPD), 4,4′-diaminodiphenylether (ODA), and 2,2′-dimethylbenzidine (MTD) in a predetermined order and adjusted composition ratios for complete dissolution. The resulting product was then heated by raising the reactor temperature to 40° C. under a nitrogen atmosphere with continuous stirring for 120 minutes, preparing a polyamic acid with a primary reaction viscosity of 1,500 cP.

The polyamic acid prepared in such a manner was stirred so that the final viscosity was in the range of 100,000 to 120,000 cP.

The catalyst and the dehydrating agent were adjusted in contents and added to the final polyamic acid prepared above. Then, using an applicator, a polyimide film was manufactured.

### EXAMPLES AND COMPARATIVE EXAMPLES

Polyimide films were manufactured according to the preparation example described above, but each content of the acid dianhydride and diamine components in examples and comparative examples were adjusted, as shown in Table 1 below.

TABLE 1

| | Acid dianhydride (mol %) | | | Diamine (mol %) | | |
|---|---|---|---|---|---|---|
| | BPDA | PMDA | BTDA | MTD | ODA | PPD |
| Example 1 | 50 | 50 | — | — | 13 | 87 |
| Example 2 | 50 | 50 | — | 40 | — | 60 |
| Example 3 | 50 | 50 | — | 45 | — | 55 |
| Example 4 | 100 | — | — | — | — | 100 |
| Example 5 | — | 50 | 50 | 35 | — | 65 |
| Example 6 | 30 | 50 | 20 | 30 | — | 70 |
| Comparative Example 1 | 40 | 60 | — | — | — | 100 |
| Comparative Example 2 | — | 100 | — | — | 75 | 25 |
| Comparative Example 3 | 35 | 65 | — | — | 100 | — |
| Comparative Example 4 | 40 | 60 | — | 25 | — | 75 |
| Comparative Example 5 | 47 | 53 | — | 60 | — | 40 |

The dimensional measurement values (200° C.), dimensional measurement values (50° C.), coefficients of thermal expansion (CTE), and moisture absorption rates of the manufactured polyimide films were measured. The results thereof are shown in Table 2 below.

### (1) Measurement of Temperature-Rise Coefficient of Thermal Expansion

Each polyimide film was stored for 48 hours under a humidity condition of 50% RH. Then, dimensional changes of the polyimide film by a TMA involving a temperature rise process from 25° C. to 400° C. were measured respectively at 50° C. and 200° C. in the first run, followed by calculating the slope of a straight line connecting the dimensional measurement value of the polyimide film measured at a temperature of 200° C. and the dimensional measurement value of the polyimide film measured at a temperature of 50° C. in the first run during the temperature rise process.

Typically, CTEs are measured from the ppm/° C. slope in the temperature drop range in the first run or the temperature rise range in the second run of TMA analysis. However, to simulate the actual process and measure the dimensional changes of polyimide films under the influence of moisture, there is a need to measure the slope (ppm/° C.) of the temperature rise range in the first run of the TMA analysis, like herein.

### (2) Measurement of Coefficient of Thermal Expansion

The CTE was measured using a TA thermomechanical analyzer, model Q400. Each polyimide film is cut to 4 mm wide and 20 mm long, and the length of the sample measured is 16 mm. In this case, the sample is measured in the TD.

The slope in the temperature range of 50° C. to 200° C. was measured by applying a tension of 0.05 N under a nitrogen atmosphere while raising the temperature from room temperature to 400° C. at a rate of 10° C./min and then cooling the temperature again at a rate of 10° C./min. In other words, the coefficient of thermal expansion corresponds to the slope measured during the temperature drop process after the temperature rise.

In the meantime, the coefficient of thermal expansion, corresponding to the slope measured in the first run during the temperature drop process, shows a value similar to the existing coefficient of thermal expansion, corresponding to the slope measured in the second run during the temperature rise process.

### (3) Measurement of Moisture Absorption Rate

The moisture absorption rate was measured on the basis of the ASTMD 570 method as follows: cutting the polyimide film into a 5 cm×5 cm square to prepare a specimen, drying the cut specimen in an oven at 50° C. for at least 24 hours to measure the weight, immersing the weighed specimen in water at 23° C. for 24 hours to measure the weight once again, and expressing the difference between the weights obtained herein as %.

TABLE 2

| | Properties | | |
|---|---|---|---|
| | | | Moisture |
| | Temperature-rise CTE | | absorption |
| | (50° C. to 200° C.) | CTE | rate |
| | (ppm/° C.) | (ppm/° C.) | (%) |
| Example 1 | 4.2 | 4.9 | 1.38 |
| Example 2 | 0.2 | 3.1 | 1.01 |
| Example 3 | −1.3 | 1.5 | 1.03 |
| Example 4 | 5.0 | 8.5 | 1.4 |
| Example 5 | 1.2 | 5.0 | 1.10 |
| Example 6 | 2.0 | 3.4 | 1.2 |
| Comparative Example 1 | −5.0 | 0.2 | 1.8 |
| Comparative Example 2 | 14.0 | 17.0 | 1.8 |
| Comparative Example 3 | 32.0 | 38.0 | 1.6 |
| Comparative Example 4 | −3.6 | 0.5 | 1.4 |
| Comparative Example 5 | −4.5 | 0.3 | 0.98 |

The temperature-rise coefficients of thermal expansion (50° C. to 200° C.) of the polyimide films of Examples 1 to 6 corresponded to −1.5 ppm/° C. or higher and 6 ppm/° C. or lower.

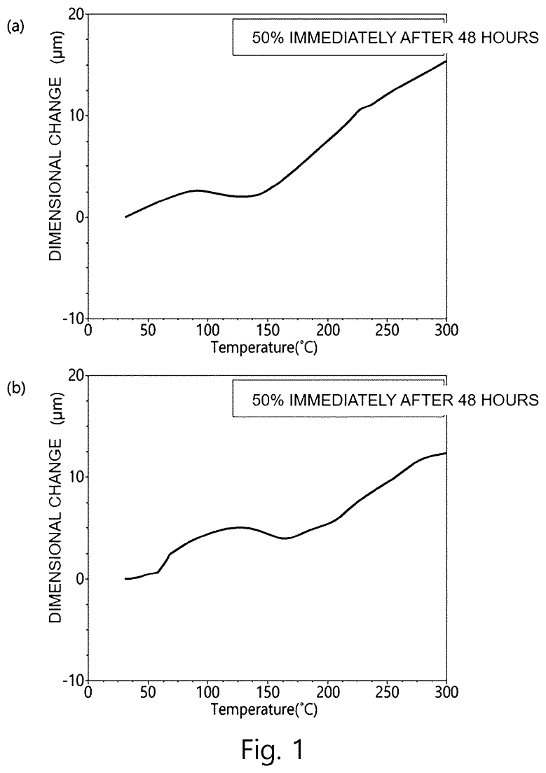

In other words, like the graphs showing the dimensional change measurement results of the polyimide films of Examples 1 and 4, shown in FIGS. 1A and 1, respectively, it was confirmed that the temperature-rise coefficient of thermal expansion, the slope of the straight line connecting the TD dimensional measurement values of the polyimide film measured at temperatures of 200° C. and 50° C. during the temperature rise process, was in the range of −1.5 ppm/° C. or higher and 6 ppm/° C. or lower.

In the meantime, in the graphs of FIGS. 1A and 1B showing the dimensional change measurement results, the dimensional change value on the Y-axis refers to the dimensional change value corresponding to the sample length of the polyimide film (16 mm) used for the TMA measurement.

The temperature-rise coefficient of thermal expansion (50° C. to 200° C.) was calculated as the slope obtained by converting the measurement results in the graph showing the dimensional change measurement results, into dimensional change values per 1 m of the polyimide film length.

In addition, the TD coefficient of thermal expansion of the polyimide films of Examples 1 to 6 was 1 ppm/° C. or higher and 10 ppm/° C. or lower, and the moisture absorption rate thereof was 1.5 wt % or less.

In comparison, the pyromellitic dianhydride content exceeded 55 mol % in the polyimide films of Comparative Examples 1 and 4, and in the polyimide film of Example 5, the paraphenylenediamine content was less than 50 mol % and 2,2′-dimethylbenzidine content exceeded 50 mol %.

Thus, the polyimide films of Comparative Examples 1, 4, and 5 had high moisture absorption rates or significantly low temperature-drop coefficients of thermal expansion (50° C. to 200° C.), resulting in shrinkage. Accordingly, the temperature-rise coefficient of thermal expansion (50° C. to 200° C.) showed values less than −1.5 ppm/° C.

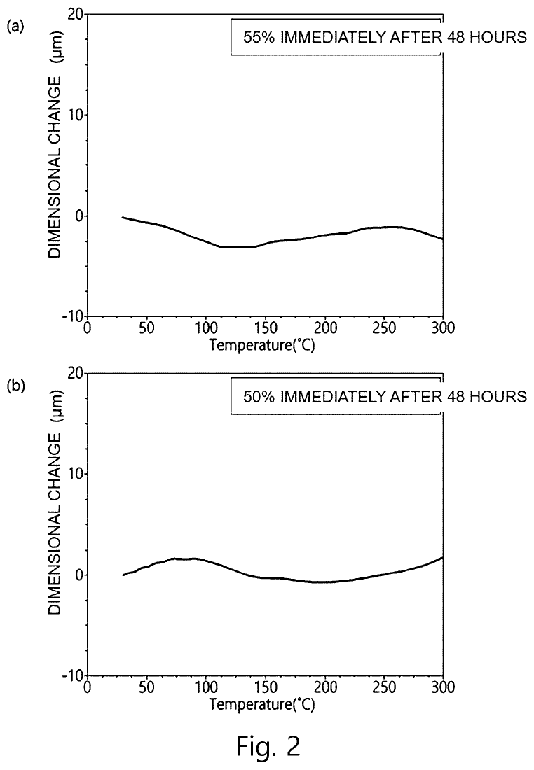

In other words, like the graphs showing the dimensional change measurement results of the polyimide films of Comparative Examples 1 and 4, shown in FIGS. 2A and 2B, respectively, the slope of the straight line connecting the TD dimensional measurement values of the polyimide film measured at temperatures of 200° C. and 50° C. during the temperature rise process after being converted into dimensional change values per 1 m of the polyimide film length corresponded to less than −1.5 ppm/° C.

In the meantime, the paraphenylenediamine content was less than 50 mol % and the 4,4′-diaminodiphenylether content exceeded 20 mol % in the polyimide films of Comparative Examples 2 and 3.

As a result, the temperature-rise coefficient of thermal expansion (50° C. to 200° C.) showed significantly large values, which failed to fall within the range of the temperature-rise coefficient of thermal expansion (50° C. to 200° C.) of the polyimide film herein. Additionally, the TD coefficient of thermal expansion showed significantly large values, deteriorating the dimensional stability of the polyimide film.

The embodiments of the present disclosure regarding the polyimide film and the manufacturing method thereof are only preferred embodiments that allow those skilled in the art to easily practice the present disclosure in the technical field to which the present disclosure belongs and are not limited to the examples described above. Accordingly, the scope of the present disclosure is not limited thereby. Thus, the true technical protection scope of the present disclosure should be defined by the technical spirit of the appended claims. Additionally, those skilled in the art will appreciate that various modifications, alternatives, and substitutions are possible, without departing from the scope and spirit of the present disclosure as disclosed in the accompanying claims. Furthermore, it is apparent that modifications capable of being easily embodied by those skilled in the art are included within the scope of the present disclosure.

### INDUSTRIAL APPLICABILITY

The present disclosure provides a polyimide film having excellent dimensional stability even after being exposed to humidity for a predetermined period of time, thereby providing a polyimide film having excellent dimensional stability in a metal foil lamination process.

Such a polyimide film can be applied to various fields in need of polyimide films having excellent dimensional stability, for example, flexible metal-clad laminates manufactured by a metalizing method and electronic components including such flexible metal-clad laminates.

1. A polyimide film having a temperature-rise coefficient of thermal expansion (50° C. to 200° C.) in a transverse direction (TD) of −1.5 ppm/° C. or higher and 6 ppm/° C. or lower in dimensional change measurement by a thermomechanical analyzer (TMA) involving a temperature rise process from 25° C. to 400° C. after being stored for 48 hours under a humidity condition of 50% RH,
wherein the temperature-rise coefficient of thermal expansion (50° C. to 200° C.) is a slope of a straight line connecting a TD dimensional measurement value of the polyimide film measured at a temperature of 200° C. and a TD dimensional measurement value of the polyimide film measured at a temperature of 50° C. in the first run during the temperature rise process, and
the TD dimensional measurement values correspond to dimensional change values calculated by converting a sample length of the polyimide film used in the TMA measurement into 1 μm.

2. The polyimide film of claim 1, wherein the polyimide film has a TD coefficient of thermal expansion of 1 ppm/° C. or higher and 10 ppm/° C. or lower.

3. The polyimide film of claim 1, wherein the polyimide film has a moisture absorption rate of 1.5 wt % or less.

4. The polyimide film of claim 1, wherein the polyimide film is obtainable by reacting one or more acid dianhydride components and one or more diamine components through imidization, the one or more acid dianhydride components selected from the group consisting of pyromellitic dianhydride (PMDA), oxydiphthalic dianhydride (ODPA), 3,3′,4,4′-biphenyltetracarboxylic dianhydride (s-BPDA), 2,3,3′,4′-biphenyltetracarboxylic dianhydride (a-BPDA), diphenylsulfone-3,4,3′,4′-tetracarboxylic dianhydride (DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (BTDA), bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic acid dianhydride, 1,4,5,8-naphthalenetetracarboxylic dianhydride, and 4,4′-(2,2-hexafluoroisopropylidene)diphthalic acid dianhydride and
the one or more diamine components selected from the group consisting of paraphenylenediamine (PPD), metaphenylenediamine, 3,3′-dimethylbenzidine, 2,2′-dimethylbenzidine, 2,4-diaminotoluene, 2,6-diaminotoluene, 3,5-diaminobenzoic acid (DABA), 4,4′-diaminodiphenylether (ODA), 3,4′-diaminodiphenylether, 4,4′-diaminodiphenylmethane(methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dimethoxybenzidine, 2,2′-dimethoxybenzidine, 3,3′-diaminodiphenylether, 3,4′-diaminodiphenylether, 4,4′-diaminodiphenylether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenylsulfoxide, 3,4′-diaminodiphenylsulfoxide, 4,4′-diaminodiphenylsulfoxide, 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene (TPE-R), 1,4-bis(3-aminophenoxy)benzene (TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis[4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane (BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, and 2,2-bis[4-(4-aminophenoxy)phenyl]-1,1,1,3,3,3-hexafluoropropane.

5. The polyimide film of claim 1, wherein the polyimide film is obtainable by reacting a polyamic acid solution through an imidization reaction, the polyamic acid solution comprising:
an acid dianhydride component comprising any one or more selected from the group consisting of 3,3′,4,4′-biphenyltetracarboxylic dianhydride (s-BPDA), pyromellitic dianhydride (PMDA), and 3,3′,4,4′-benzophenonetetracarboxylic dianhydride (BTDA); and
a diamine component comprising any one or more selected from the group consisting of paraphenylenediamine (PPD), 4,4′-diaminodiphenylether (ODA), and 2,2′-dimethylbenzidine.

6. The polyimide film of claim 5, wherein the 3,3′,4,4′-biphenyltetracarboxylic dianhydride has a content of 100 mol % or less, the pyromellitic dianhydride has a content of 55 mol % or less, and the 3,3′,4,4′-benzophenonetetracarboxylic dianhydride has a content of 60 mol % or less, based on 100 mol % of the total content of the acid dianhydride component.

7. The polyimide film of claim 5, wherein the paraphenylenediamine has a content of 50 mol % or more and 100 mol % or less, the 4,4′-diaminodiphenylether has a content of 20 mol % or less, and the 2,2′-dimethylbenzidine has a content of 50 mol % or less, based on the 100 mol % of the total content of the diamine component.

8. A method of manufacturing the polyimide film of claim 1, the method comprising:
a process of providing a polyamic acid solution to be obtained from an acid dianhydride component and a diamine component;
a process of applying the polyamic acid solution onto a support through cast coating and heating the resulting product to manufacture a self-supporting film of the polyamic acid solution; and
a process of imidizing and stretching the self-supporting film to manufacture a polyimide film.

9. A flexible metal-clad laminate comprising:
the polyimide film of claim 1; and
an electrically conductive metal foil.

10. The flexible metal-clad laminate of claim 9, wherein the metal foil is formed through coating, sputtering, or deposition.

11. (canceled)
